(19) United States
(12) Patent Application Publication
(10) Pub. No.: US 2020/0323217 A1
(43) Pub. Date: Oct. 15, 2020

(54) ANTIMICROBIAL FLOOR COATINGS AND FORMULATIONS

(71) Applicant: CORNING INCORPORATED, CORNING, NY (US)

(72) Inventors: Jackie Lynn Frederick, Covington, PA (US); Joydeep Lahiri, Corning, NY (US); Paul Francis Novak, JR., Corning, NY (US); Florence Christine Monique Verrier, Corning, NY (US)

(21) Appl. No.: 16/760,784

(22) PCT Filed: Oct. 31, 2018
(86) PCT No.: PCT/US2018/058383

§ 371 Date: Apr. 30, 2020

Related U.S. Application Data
(60) Provisional application No. 62/579,931, filed on Nov. 1, 2017.

(51) Int. Cl. A01N 59/20; A01N 25/02; C09D 5/14; C09D 163/00; C09D 133/04; C09D 7/20; C09D 7/61

(52) U.S. Cl. CPC A01N 59/20; A01N 25/02; C09D 5/14; C09D 7/61; C09D 133/04; C09D 7/20; C09D 163/00

(57) ABSTRACT

An antimicrobial floor coating is provided that includes a matrix comprising a polymeric material; and a plurality of second phase particles comprising a controlled release agent, the controlled release agent comprising a plurality of antimicrobial copper ions. The polymeric material comprises an epoxy and an acrylic, and the plurality of second phase particles is distributed within the matrix. Further, an exterior surface of the coating exhibits at least a 2 log reduction in a concentration of Staphylococcus aureus under a Modified EPA Copper Test Protocol. Further, the controlled release agent can comprise a phase-separable glass.

### CROSS-REFERENCE TO RELATED APPLICATIONS

This application claims the benefit of priority under 35 U.S.C. § 119 of U.S. Provisional Application Ser. No. 62/579,931 filed on Nov. 1, 2017, the content of which is relied upon and incorporated herein by reference in its entirety.

### BACKGROUND

The present disclosure relates generally to antimicrobial floor coatings and formulations. More particularly, the various embodiments described herein relate to antimicrobial floor coatings and formulations having polymeric material and antimicrobial copper ions.

Floor coatings and floor paints are important for aesthetics and wear resistance of underlying concrete, wood and other flooring materials. These floor coatings and paints can be prone to contamination from microorganisms (e.g., bacteria, fungi, viruses, and the like), particularly as compared to coatings and paints employed on other surfaces (e.g., walls). Yet floor coatings and paints are also required to exhibit higher durability and wear resistance than their counterparts employed on other surfaces, such as walls.

While there are a few floor coatings presently on the market that claim to have antimicrobial properties, none of these coatings demonstrate antimicrobial efficacy under the rigorous antimicrobial standards set forth by the U.S. Environmental Protection Agency (“EPA”). Rather, it is believed that these conventional antimicrobial coatings exhibit antimicrobial performance as judged by a test protocol, such as the Japanese Industrial Standard JISZ 2801 test, that provides for antimicrobial contact under wet conditions. In particular, these protocols promote interactions between the antimicrobial agents in the coatings and the microorganisms on the wet or moist test surface over a 24 hour period. In contrast, EPA-derived antimicrobial test protocols are significantly more rigorous and more realistic given that they require ‘dry’ test surfaces and a quicker kill over a 2 hour period.

Accordingly, there is a need for antimicrobial floor coatings and formulations that offer wear resistance and antimicrobial efficacy under ‘wet’ test conditions. The required degree of antimicrobial efficacy can include the demonstration of a 2 log reduction in a concentration of Staphylococcus aureus (S. aureus), as determined under a test procedure derived from a protocol of the United States Environmental Protection Agency (the “Modified EPA Copper Test Protocol”). As S. aureus is one of the key bacteria against which a kill must be demonstrated by the Modified EPA Copper Test Protocol, a kill of S. aureus may be considered reasonable evidence of efficacy against a broad range of other bacteria (e.g., Eschecheria coli, Pseudomonas aeruginosa, and Enterobacter aerogenes).

### SUMMARY

A first aspect of the present disclosure pertains to an antimicrobial floor coating that includes a matrix comprising a polymeric material; and a plurality of second phase particles comprising a controlled release agent, the controlled release agent comprising a plurality of antimicrobial copper ions. The polymeric material comprises an epoxy and an acrylic, and the plurality of second phase particles is distributed within the matrix. Further, an exterior surface of the coating exhibits at least a 2 log reduction in a concentration of Staphylococcus aureus under a Modified EPA Copper Test Protocol. In embodiments, the exterior surface of the coating can exhibit at least a 3 log reduction in a concentration of Staphylococcus aureus under a Modified EPA Copper Test Protocol.

In implementations of the first aspect, the controlled release agent can further comprise a phase-separable glass. The floor coating can further comprise one or more pigments. The plurality of antimicrobial copper ions can be at a concentration of about 2 wt. % or less in the coating.

In some implementations of these floor coatings, the phase-separable glass can comprise at least one of B₂O₃, P₂O₅ and R₂O, and the plurality of antimicrobial ions is cuprite comprising a plurality of Cu⁺ ions. The phase-separable glass can also comprise: SiO₂ in the range from about 40 to about 70 mol %, Al₂O₃ in the range from about 0 to about 20 mol %, Cu-containing oxide in the range from about 10 to about 50 mol %, CaO in the range from about 0 to about 15 mol %, MgO in the range from about 0 to about 15 mol %, P₂O₅ in the range from about 0 to about 25 mol %, B₂O₃ in the range from about 0 to about 25 mol %, K₂O in the range from about 0 to about 20 mol %, ZnO in the range from about 0 to about 5 mol %, Na₂O in the range from about 0 to about 20 mol %, Fe₂O₃ in the range from about 0 to about 5 mol %, and an optional nucleating agent comprising either one or both of TiO₂ and ZrO₂, wherein the amount of the Cu-containing oxide is greater than the amount of Al₂O₃.

In further implementations of these floor coatings, the polymeric material is derived from a no-mix, one-part epoxy acrylic floor paint. The phase-separable glass can comprise: about 45 mol % SiO₂, about 35 mol % CuO, about 7.5 mol % K₂O, about 7.5 mol % B₂O₃ and about 5 mol % P₂O₅. Further, the epoxy can be derived from an epoxy precursor that comprises one or more of dipropylene glycol monomethyl ether, dipropylene glycol butoxy ether, and ethylene glycol, the acrylic can comprise a styrene acrylic polymer, and the matrix can further comprise nepheline syenite.

A further aspect of the present disclosure pertains to an antimicrobial floor coating formulation that includes an epoxy; an acrylic polymer; an aqueous medium; and a plurality of second phase particles comprising a controlled release agent, the controlled release agent comprising a plurality of antimicrobial copper ions. Further, the plurality of second phase particles is at a concentration that ranges from about 25 g/gal to about 150 g/gal of the formulation. In embodiments, the plurality of second phase particles is at a concentration that ranges from about 50 g/gal to about 125 g/gal of the formulation. In further implementations of this aspect, an exterior surface of the formulation upon drying of the aqueous medium exhibits at least a 2 log reduction in a concentration of Staphylococcus aureus under a Modified EPA Copper Test Protocol.

According to aspects of these formulations, the controlled release agent can further comprise a phase-separable glass. The floor coating formulation can further comprise one or more pigments.

In some implementations of these floor coating formulations, the phase-separable glass can comprise at least one of B₂O₃, P₂O₅ and R₂O, and the plurality of antimicrobial ions is cuprite comprising a plurality of Cu⁺ ions. The phase-separable glass can also comprise: SiO₂ in the range from about 40 to about 70 mol %, Al₂O₃ in the range from about 0 to about 20 mol %, Cu-containing oxide in the range from about 10 to about 50 mol %, CaO in the range from about 0 to about 15 mol %, MgO in the range from about 0 to about 15 mol %, P₂O₅ in the range from about 0 to about 25 mol %, B₂O₃ in the range from about 0 to about 25 mol %, K₂O in the range from about 0 to about 20 mol %, ZnO in the range from about 0 to about 5 mol %, Na₂O in the range from about 0 to about 20 mol %, Fe₂O₃ in the range from about 0 to about 5 mol %, and an optional nucleating agent comprising either one or both of TiO₂ and ZrO₂, wherein the amount of the Cu-containing oxide is greater than the amount of Al₂O₃.

In further implementations of these floor coating formulations, the epoxy, the acrylic polymer and the aqueous medium are derived from a no-mix, one-part epoxy acrylic floor paint. The phase-separable glass can comprise: about 45 mol % SiO₂, about 35 mol % CuO, about 7.5 mol % K₂O, about 7.5 mol % B₂O₃ and about 5 mol % P₂O₅. Further, the epoxy can be derived from an epoxy precursor that comprises one or more of dipropylene glycol monomethyl ether, dipropylene glycol butoxy ether, and ethylene glycol, the acrylic can comprise a styrene acrylic polymer, and the matrix can further comprise nepheline syenite.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic, perspective view of an antimicrobial floor coating according to an aspect of the disclosure.

FIG. 1A is a plan view of an exterior surface of the antimicrobial floor coating depicted in FIG. 1.

FIG. 2 is a bar chart depicting the antimicrobial efficacy of comparative two-part epoxy floor paint with phase-separable, copper-containing glass, as tested under the Modified EPA Copper Test Protocol.

FIG. 3 is a bar chart depicting the antimicrobial efficacy of one-part epoxy/acrylic floor paint with phase-separable, copper-containing glass, as tested under the Modified EPA Copper Test Protocol, according to aspects of the disclosure.

### DETAILED DESCRIPTION

Reference will now be made in detail to various embodiment(s), examples of which are illustrated in the accompanying drawings.

Aspects of the disclosure generally pertain to antimicrobial floor coatings and formulations. More particularly, the various embodiments described herein relate to antimicrobial floor coatings and formulations having polymeric material that comprises an epoxy and an acrylic, along with antimicrobial copper ions. In preferred implementations, the polymeric material is derived from a no-mix, one-part epoxy acrylic floor paint. These antimicrobial floor coatings have an unexpected combination of high durability, indicative of floor coatings, and antimicrobial efficacy will kills of >99% of human pathogens under the Modified EPA Copper Test Protocol. The antimicrobial properties of the floor coatings and floor coating formulations disclosed herein include antiviral and/or antibacterial properties. As used herein the term “antimicrobial,” means a material, or a surface of a material that will kill or inhibit the growth of bacteria, viruses, and/or fungi. The term as used herein does not mean the material or the surface of the material will kill or inhibit the growth of all species of microbes within such families, but that it will kill or inhibit the growth or one or more species of microbes from such families.

As used herein the term “log reduction” means −log (Cₐ/C₀), where Ca=the colony form unit (CFU) number of the antimicrobial surface and C₀=the colony form unit (CFU) of the control surface that is not an antimicrobial surface. As an example, a “3 log” reduction equals about 99.9% of the bacteria, viruses, and/or fungi killed.

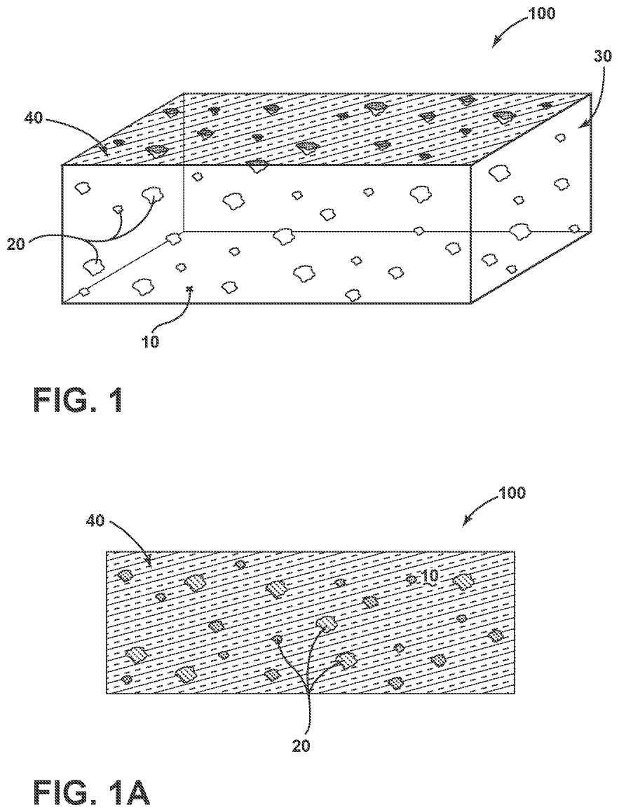

Referring to FIG. 1, an antimicrobial floor coating 100 is provided in an exemplary, schematic form. The coating 100 includes a matrix 10 that comprises a polymeric material. In embodiments, the polymeric material comprises an epoxy and an acrylic. The coating 100 also includes a plurality of second phase particles 20. The particles 20 comprise a controlled release agent, with the agent comprising a plurality of antimicrobial copper ions. In embodiments, the controlled release agent further comprises a phase-separable glass, the phase-separable glass comprising a copper-containing antimicrobial agent. Further, the plurality of particles 20 can be distributed within the matrix 10 at a second phase volume fraction. As also depicted in FIG. 1, the coating 100 defines an exterior surface 40 that includes an exposed portion of the matrix 10 and the plurality of the second phase particles 20. The exposed portion of the exterior surface 40 is also depicted in the plan view of FIG. 1A. In certain implementations, other exterior surfaces 30 of the coating 100 can also include such exposed portions.

Note that the coating 100 is depicted in FIG. 1 in a free-standing form, i.e., without its underlying substrate (e.g., a wood flooring, concrete flooring, etc.). Hence, the coating 100 is contemplated as being placed over a flooring substrate (e.g., by a coating process). Further, the rectangular nature of the coating 100 depicted in FIG. 1 is merely stylistic in the sense that it is used for purposes of clarity in outlining the features of the coating, notwithstanding that actual coatings 100 may possess various forms comparable to a typical floor coating that lack sharp, right angle edges. Hence, the other exterior surfaces 30 of the coating 100 may be in various orientations relative to the exposed portion of the exterior surface 40.

Referring again to FIG. 1, the exposed portion of the exterior surface 40 of the coating 100 can, at least in some aspects, contain a certain percentage of second phase particles 20 that are exposed with portions of the their surfaces outside of the surrounding matrix 10. In certain implementations, the exposed portion of the plurality of the second phase particles 20 can be distributed within the exposed portion of the matrix 10 at a second phase area fraction within ±25% of the second phase volume fraction. That is, in these implementations, the exposed portion of the exterior surface 40 possesses roughly the same or similar percentage of second phase particles as the bulk of the antimicrobial floor coating 100.

As outlined earlier, the second phase particles 20 of the antimicrobial floor coating 100 comprise a controlled release agent, which may include a phase-separable glass with a copper-containing antimicrobial agent. The phase-separable glass employed in the particles 20 is described in U.S. patent application Ser. No. 14/623,077, filed on Feb. 16, 2015, now issued as U.S. Pat. No. 9,622,483, the salient portions of which related to phase-separable glass are hereby incorporated by reference within this disclosure. In one or more embodiments, the phase-separable glasses employed in the second phase particles 20 include a Cu species. In one or more alternative embodiments, the Cu species may include Cu¹⁺, Cu⁰, and/or Cu²⁺. The combined total of the Cu species may be about 10 wt. % or more. However, as will be discussed in more detail below, the amount of Cu¹⁺ is minimized or is reduced such that the antimicrobial glass is substantially free of Cu²⁺. The Cu¹⁺ ions may be present on or in the surface and/or the bulk of the antimicrobial glass. In some embodiments, the Cu¹⁺ ions are present in the glass network and/or the glass matrix of the antimicrobial glass. Where the Cu¹⁺ ions are present in the glass network, the Cu¹⁺ ions are atomically bonded to the atoms in the glass network. Where the Cu¹⁺ ions are present in the glass matrix, the Cu¹⁺ ions may be present in the form of Cu¹⁺ crystals that are dispersed in the glass matrix. In some embodiments the Cu¹⁺ crystals include cuprite (Cu₂O). In such embodiments, where Cu¹⁺ crystals are present, the material may be referred to as an antimicrobial glass ceramic, which is intended to refer to a specific type of glass with crystals that may or may not be subjected to a traditional ceramming process by which one or more crystalline phases are introduced and/or generated in the glass. Where the Cu¹⁺ ions are present in a non-crystalline form, the material may be referred to as an antimicrobial glass. In some embodiments, both Cu¹⁺ crystals and Cu¹⁺ ions not associated with a crystal are present in the antimicrobial glasses described herein.

In further embodiments, the second phase particles 20 can comprise other controlled release agents (i.e., agents other than a phase-separable glass) that comprise a copper-containing antimicrobial agent. These other controlled release agents can include, but are not limited to, inorganic species like zeolites, organic species like micelles and amphiphilic compounds, hydrogels, caged compounds like cyclodextrins, other encapsulating polymers, and hybrid/nanoparticle species such as core-shell particles (e.g., a cuprite core-silica shell). Further, in some implementations, the controlled release agent can comprise a phase-separable glass and any one or more of these other controlled release agents.

In one or more aspects of the antimicrobial floor coating 100, the antimicrobial glass employed in the second phase particles 20 may be formed from a composition that can include, in mole percent, SiO₂ in the range from about 40 to about 70, Al₂O₃ in the range from about 0 to about 20, a copper-containing oxide in the range from about 10 to about 30, CaO in the range from about 0 to about 15, MgO in the range from about 0 to about 15, P₂O₅ in the range from about 0 to about 25, B₂O₃ in the range from about 0 to about 25, K₂O in the range from about 0 to about 20, ZnO in the range from about 0 to about 5, Na₂O in the range from about 0 to about 20, and/or Fe₂O₃ in the range from about 0 to about 5. In such embodiments, the amount of the copper-containing oxide is greater than the amount of Al₂O₃. In some embodiments, the composition may include a content of R₂O, where R may include K, Na, Li, Rb, Cs, and combinations thereof.

According to another aspect of the antimicrobial floor coating 100, the phase-separable glass, as or part of the controlled release agent, can comprise at least one of B₂O₃, P₂O₅ and R₂O, and the plurality of antimicrobial ions is cuprite comprising a plurality of Cu⁺ ions. The phase-separable glass can also comprise: SiO₂ in the range from about 40 to about 70 mol %, Al₂O₃ in the range from about 0 to about 20 mol %, Cu-containing oxide in the range from about 10 to about 50 mol %, CaO in the range from about 0 to about 15 mol %, MgO in the range from about 0 to about 15 mol %, P₂O₅ in the range from about 0 to about 25 mol %, B₂O₃ in the range from about 0 to about 25 mol %, K₂O in the range from about 0 to about 20 mol %, ZnO in the range from about 0 to about 5 mol %, Na₂O in the range from about 0 to about 20 mol %, Fe₂O₃ in the range from about 0 to about 5 mol %, and an optional nucleating agent comprising either one or both of TiO₂ and ZrO₂, wherein the amount of the Cu-containing oxide is greater than the amount of Al₂O₃. According to a preferred implementation, the phase-separable glass can comprise: about 45 mol % SiO₂, about 35 mol % CuO, about 7.5 mol % K₂O, about 7.5 mol % B₂O₃ and about 5 mol % P₂O₅ (“Cu-Glass” or “Cu glass”).

In the embodiments of the compositions described herein, SiO₂ serves as the primary glass-forming oxide. The amount of SiO₂ present in a composition should be enough to provide glasses that exhibit the requisite chemical durability suitable for its use or application within the antimicrobial floor coating 100. The upper limit of SiO₂ may be selected to control the melting temperature of the compositions described herein. For example, excess SiO₂ could drive the melting temperature at 200 poise to high temperatures at which defects such as fining bubbles may appear or be generated during processing and in the resulting glass. Furthermore, compared to most oxides, SiO₂ decreases the compressive stress created by an ion exchange process of the resulting glass. In other words, glass formed from compositions with excess SiO₂ may not be ion-exchangeable to the same degree as glass formed from compositions without excess SiO₂. Additionally or alternatively, SiO₂ present in the compositions according to one or more embodiments could increase the plastic deformation prior break properties of the resulting glass. An increased SiO₂ content in the glass formed from the compositions described herein may also increase the indentation fracture threshold of the glass.

In one or more aspects of the antimicrobial floor coating 100, the composition of the controlled release agent, in the form of a phase-separable glass, includes SiO₂ in an amount, in mole percent, in the range from about 40 to about 70, from about 40 to about 69, from about 40 to about 68, from about 40 to about 67, from about 40 to about 66, from about 40 to about 65, from about 40 to about 64, from about 40 to about 63, from about 40 to about 62, from about 40 to about 61, from about 40 to about 60, from about 41 to about 70, from about 42 to about 70, from about 43 to about 70, from about 44 to about 70, from about 45 to about 70, from about 46 to about 70, from about 47 to about 70, from about 48 to about 70, from about 49 to about 70, from about 50 to about 70, from about 41 to about 69, from about 42 to about 68, from about 43 to about 67 from about 44 to about 66 from about 45 to about 65, from about 46 to about 64, from about 47 to about 63, from about 48 to about 62, from about 49 to about 61, from about 50 to about 60, and all ranges and sub-ranges therebetween.

In one or more aspects of the antimicrobial floor coating 100, the composition of the controlled release agent, in the form of phase-separable glass, includes Al₂O₃ in an amount, in mole percent, in the range from about 0 to about 20, from about 0 to about 19, from about 0 to about 18, from about 0 to about 17, from about 0 to about 16, from about 0 to about 15, from about 0 to about 14, from about 0 to about 13, from about 0 to about 12, from about 0 to about 11 from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1, and all ranges and sub-ranges therebetween. In some embodiments, the composition is substantially free of Al₂O₃. As used herein, the phrase “substantially free”, with respect to the components of the composition and/or resulting glass, means that the component is not actively or intentionally added to the compositions during initial batching or subsequent post processing (e.g., ion exchange process), but may be present as an impurity. For example, a composition, a glass may be describe as being substantially free of a component, when the component is present in an amount of less than about 0.01 mol %.

The amount of Al₂O₃ may be adjusted to serve as a glass-forming oxide and/or to control the viscosity of molten compositions within the phase-separable glass, as employed as the controlled release agent of the second phase particles 20. Without being bound by theory, it is believed that when the concentration of alkali oxide (R₂O) in a composition is equal to or greater than the concentration of Al₂O₃, the aluminum ions are found in tetrahedral coordination with the alkali ions acting as charge-balancers. This tetrahedral coordination greatly enhances various post-processing (e.g., ion exchange process) of glasses formed from such compositions. Divalent cation oxides (RO) can also charge balance tetrahedral aluminum to various extents. While elements such as calcium, zinc, strontium, and barium behave equivalently to two alkali ions, the high field strength of magnesium ions causes them to not fully charge balance aluminum in tetrahedral coordination, resulting in the formation of five- and six-fold coordinated aluminum. Generally, Al₂O₃ can play an important role in ion-exchangeable compositions and strengthened glasses since it enables a strong network backbone (i.e., high strain point) while allowing for the relatively fast diffusivity of alkali ions. However, when the concentration of Al₂O₃ is too high, the composition may exhibit lower liquidus viscosity and, thus, Al₂O₃ concentration may be controlled within a reasonable range. Moreover, as will be discussed in more detail below, excess Al₂O₃ has been found to promote the formation of Cu²⁺ ions, instead of the desired Cu¹⁺ ions.

In one or more aspects of the antimicrobial floor coating 100, the composition of the phase-separable glass, as employed as the controlled release agent of the second phase particles 20, includes a copper-containing oxide in an amount, in mole percent, in the range from about 10 to about 50, from about 10 to about 49, from about 10 to about 48, from about 10 to about 47, from about 10 to about 46, from about 10 to about 45, from about 10 to about 44, from about 10 to about 43, from about 10 to about 42, from about 10 to about 41, from about 10 to about 40, from about 10 to about 39, from about 10 to about 38, from about 10 to about 37, from about 10 to about 36, from about 10 to about 35, from about 10 to about 34, from about 10 to about 33, from about 10 to about 32, from about 10 to about 31, from about 10 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 11 to about 50, from about 12 to about 50, from about 13 to about 50, from about 14 to about 50, from about 15 to about 50, from about 16 to about 50, from about 17 to about 50, from about 18 to about 50, from about 19 to about 50, from about 20 to about 50, from about 10 to about 30, from about 11 to about 29, from about 12 to about 28, from about 13 to about 27, from about 14 to about 26, from about 15 to about 25, from about 16 to about 24, from about 17 to about 23, from about 18 to about 22, from about 19 to about 21, and all ranges and sub-ranges therebetween. In one or more specific embodiments, the copper-containing oxide may be present in the composition in an amount of about 20 mol %, about 25 mol %, about 30 mol % or about 35 mol %. The copper-containing oxide may include CuO, Cu₂O and/or combinations thereof. Further, in some embodiments of the antimicrobial floor coating 100, the antimicrobial copper ions in the controlled release agent can be at a concentration of about 2 wt. % or less in the coating, e.g., at about 2 wt. %, about 1.9 wt. %, about 1.8 wt. %, about 1.7 wt. %, about 1.6 wt. %, about 1.5 wt. %, about 1.4 wt. %, about 1.3 wt. %, about 1.2 wt. %, about 1.1 wt. %, about 1.0 wt. %, about 0.9 wt. %, about 0.8 wt. %, about 0.7 wt. %, about 0.6 wt. %, about 0.5 wt. %, about 0.4 wt. %, about 0.3 wt. %, about 0.2 wt. %, about 0.1 wt. %, and all concentrations between these values.

The copper-containing oxides in the composition form the Cu¹⁺ ions present in the resulting glass. Copper may be present in the composition and/or the glasses including the composition in various forms including Cu⁰, Cu¹⁺, and Cu²⁺. Copper in the Cu⁰ or Cu¹⁺ forms provide antimicrobial activity. However forming and maintaining these states of antimicrobial copper are difficult and often, in known compositions, Cu²⁺ ions are formed instead of the desired Cu⁰ or Cu¹⁺ ions.

In one or more aspects of the antimicrobial floor coating 100, the amount of copper-containing oxide in a phase-separable glass, as employed as the controlled release agent of the second phase particles 20, is greater than the amount of Al₂O₃ in the composition. Without being bound by theory, it is believed that an about equal amount of copper-containing oxides and Al₂O₃ in the composition results in the formation of tenorite (CuO) instead of cuprite (Cu₂O). The presence of tenorite decreases the amount of Cu¹⁺ in favor of Cu²⁺ and thus leads to reduced antimicrobial activity. Moreover, when the amount of copper-containing oxides is about equal to the amount of Al₂O₃, aluminum prefers to be in a four-fold coordination and the copper in the composition and resulting glass remains in the Cu²⁺ form so that the charge remains balanced. Where the amount of copper-containing oxide exceeds the amount of Al₂O₃, then it is believed that at least a portion of the copper is free to remain in the Cu¹⁺ state, instead of the Cu¹⁺ state, and thus the presence of Cu¹⁺ ions increases.

In one or more aspects of the antimicrobial floor coating 100, the composition of one or more embodiments of the phase-separable glass, as employed as the controlled release agent of the second phase particles 20, includes P₂O₅ in an amount, in mole percent, in the range from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1, and all ranges and sub-ranges therebetween. In some embodiments, the composition includes about 10 mol % or about 5 mol % P₂O₅ or, alternatively, may be substantially free of P₂O₅.

In one or more embodiments, P₂O₅ forms at least part of a less durable phase or a degradable phase in the phase-separable glass, as employed as the controlled release agent of the second phase particles 20, of the antimicrobial floor coating 100. The relationship between the degradable phase(s) of the glass and antimicrobial activity is discussed in greater detail herein. In one or more embodiments, the amount of P₂O₅ may be adjusted to control crystallization of the composition and/or glass during forming. For example, when the amount of P₂O₅ is limited to about 5 mol % or less or even 10 mol % or less, crystallization may be minimized or controlled to be uniform. However, in some embodiments, the amount or uniformity of crystallization of the composition and/or glass may not be of concern and thus, the amount of P₂O₅ utilized in the composition may be greater than 10 mol %.

In one or more embodiments, the amount of P₂O₅ in the composition may be adjusted based on the desired damage resistance of the phase-separable glass, as employed as the controlled release agent of the second phase particles 20, of the antimicrobial floor coating 100, despite the tendency for P₂O₅ to form a less durable phase or a degradable phase in the glass. Without being bound by theory, P₂O₅ can decrease the melting viscosity relative to SiO₂. In some instances, P₂O₅ is believed to help to suppress zircon breakdown viscosity (i.e., the viscosity at which zircon breaks down to form ZrO₂) and may be more effective in this regard than SiO₂. When glass is to be chemically strengthened via an ion exchange process, P₂O₅ can improve the diffusivity and decrease ion exchange times, when compared to other components that are sometimes characterized as network formers (e.g., SiO₂ and/or B₂O₃).

In one or more aspects of the antimicrobial floor coating 100, the composition of one or more embodiments of the phase-separable glass, as employed as the controlled release agent of the second phase particles 20, includes B₂O₃ in an amount, in mole percent, in the range from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1, and all ranges and sub-ranges therebetween. In some embodiments, the composition includes a non-zero amount of B₂O₃, which may be, for example, about 10 mol % or about 5 mol %. The composition of some embodiments may be substantially free of B₂O₃.

In one or more embodiments, B₂O₃ forms a less durable phase or a degradable phase in the phase-separable glass, as employed as the controlled release agent of the second phase particles 20, of the antimicrobial floor coating 100. The relationship between the degradable phase(s) of the glass and antimicrobial activity is discussed in greater detail herein. Without being bound by theory, it is believed the inclusion of B₂O₃ in compositions imparts damage resistance in glasses incorporating such compositions, despite the tendency for B₂O₃ to form a less durable phase or a degradable phase in the glass. The composition of one or more embodiments includes one or more alkali oxides (R₂O) (e.g., Li₂O, Na₂O, K₂O, Rb₂O, and/or Cs₂O). In some embodiments, the alkali oxides modify the melting temperature and/or liquidus temperatures of such compositions. In one or more embodiments, the amount of alkali oxides may be adjusted to provide a composition exhibiting a low melting temperature and/or a low liquidus temperature. Without being bound by theory, the addition of alkali oxide(s) may increase the coefficient of thermal expansion (CTE) and/or lower the chemical durability of the antimicrobial glasses that include such compositions. In some cases these attributes may be altered dramatically by the addition of alkali oxide(s).

In one or more aspects of the antimicrobial floor coating 100, the composition of one or more embodiments of the phase-separable glass, as employed as the controlled release agent of the second phase particles 20, may include one or more divalent cation oxides, such as alkaline earth oxides and/or ZnO. Such divalent cation oxides may be included to improve the melting behavior of the compositions.

In one or more aspects of the antimicrobial floor coating 100, the composition of one or more embodiments of the phase-separable glass, as employed as the controlled release agent of the second phase particles 20, may include CaO in an amount, in mole percent, in the range from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1, and all ranges and sub-ranges therebetween. In some embodiments, the composition is substantially free of CaO.

In one or more aspects of the antimicrobial floor coating 100, the composition of one or more embodiments of the phase-separable glass, as employed as the controlled release agent of the second phase particles 20, may include MgO in an amount, in mole percent, in the range from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1, and all ranges and sub-ranges therebetween. In some embodiments, the composition is substantially free of MgO.

In one or more aspects of the antimicrobial floor coating 100, the composition of one or more embodiments of the phase-separable glass, as employed as the controlled release agent of the second phase particles 20, may include ZnO in an amount, in mole percent, in the range from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1, and all ranges and sub-ranges therebetween. In some embodiments, the composition is substantially free of ZnO.

In one or more aspects of the antimicrobial floor coating 100, the composition of one or more embodiments of the phase-separable glass, as employed as the controlled release agent of the second phase particles 20, may include Fe₂O₃, in mole percent, in the range from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1, and all ranges and sub-ranges therebetween. In some embodiments, the composition is substantially free of Fe₂O₃.

In one or more aspects of the antimicrobial floor coating 100, the composition of one or more embodiments of the phase-separable glass, as employed as the controlled release agent of the second phase particles 20, may include one or more colorants, e.g., additives, pigments or the like that imbue color in the coating 100. Examples of such colorants include NiO, TiO₂, Fe₂O₃, Cr₂O₃, Co₃O₄ and other known colorants and pigments. In some embodiments, the one or more colorants may be present in an amount in the range up to about 10 mol %. In some instances, the one or more colorants may be present in an amount in the range from about 0.01 mol % to about 10 mol %, from about 1 mol % to about 10 mol %, from about 2 mol % to about 10 mol %, from about 5 mol % to about 10 mol %, from about 0.01 mol % to about 8 mol %, or from about 0.01 mol % to about 5 mol %. In some aspects, the colorant employed in the second phase particles 20 is selected to match the color of the matrix employed in the antimicrobial floor coating 100.

In one or more aspects of the antimicrobial floor coating 100, the composition of one or more embodiments of the phase-separable glass, as employed as the controlled release agent of the second phase particles 20, may include one or more nucleating agents. Exemplary nucleating agents include TiO₂, ZrO₂ and other known nucleating agents in the art. The composition can include one or more different nucleating agents. The nucleating agent content of the composition may be in the range from about 0.01 mol % to about 1 mol %. In some instances, the nucleating agent content may be in the range from about 0.01 mol % to about 0.9 mol %, from about 0.01 mol % to about 0.8 mol %, from about 0.01 mol % to about 0.7 mol %, from about 0.01 mol % to about 0.6 mol %, from about 0.01 mol % to about 0.5 mol %, from about 0.05 mol % to about 1 mol %, from about 0.1 mol % to about 1 mol %, from about 0.2 mol % to about 1 mol %, from about 0.3 mol % to about 1 mol %, or from about 0.4 mol % to about 1 mol %, and all ranges and sub-ranges therebetween.

The phase-separable glasses of the foregoing compositions, as employed as the controlled release agent of the second phase particles 20, of the antimicrobial floor coating 100, may include a plurality of Cu¹⁺ ions. In some embodiments, such Cu¹⁺ ions form part of the glass network and may be characterized as a glass modifier. Without being bound by theory, where Cu¹⁺ ions are part of the glass network, it is believed that during typical glass formation processes, the cooling step of the molten glass occurs too rapidly to allow crystallization of the copper-containing oxide (e.g., CuO and/or Cu₂O). Thus the Cu¹⁺ remains in an amorphous state and becomes part of the glass network. In some cases, the total amount of Cu¹⁺ ions, whether they are in a crystalline phase or in the glass matrix, may be even higher, such as up to 40 mol %, up to 50 mol %, or up to 60 mol %.

In one or more embodiments, the phase-separable glasses formed from the compositions disclosed herein, as employed as the controlled release agent of the second phase particles 20 of the antimicrobial floor coating 100, include Cu¹⁺ ions that are dispersed in the glass matrix as Cu¹⁺ crystals. In one or more embodiments, the Cu¹⁺ crystals may be present in the form of cuprite. The cuprite present in the glass may form a phase that is distinct from the glass matrix or glass phase. In other embodiments, the cuprite may form part of or may be associated with one or more glasses phases (e.g., the durable phase described herein). The Cu¹⁺ crystals may have an average major dimension of about 5 micrometers (μm) or less, about 4 micrometers (μm) or less, about 3 micrometers (μm) or less, about 2 micrometers (μm) or less, about 1.9 micrometers (μm) or less, about 1.8 micrometers (μm) or less, about 1.7 micrometers (μm) or less, about 1.6 micrometers (μm) or less, about 1.5 micrometers (μm) or less, about 1.4 micrometers (μm) or less, about 1.3 micrometers (μm) or less, about 1.2 micrometers (μm) or less, about 1.1 micrometers or less, about 1 micrometers or less, about 0.9 micrometers (μm) or less, about 0.8 micrometers (μm) or less, about 0.7 micrometers (μm) or less, about 0.6 micrometers (μm) or less, about 0.5 micrometers (μm) or less, about 0.4 micrometers (μm) or less, about 0.3 micrometers (μm) or less, about 0.2 micrometers (μm) or less, about 0.1 micrometers (μm) or less, about 0.05 micrometers (μm) or less, and all ranges and sub-ranges therebetween. As used herein and with respect to the phrase “average major dimension”, the word “average” refers to a mean value and the word “major dimension” is the greatest dimension of the particle as measured by scanning electron microscopy (SEM). In some embodiments, the cuprite phase may be present in the glass of the second phase particles 20 of the antimicrobial composite article 100 in an amount of at least about 10 wt. %, at least about 15 wt. %, at least about 20 wt. %, at least about 25 wt. %, and all ranges and subranges therebetween of the antimicrobial glass. In certain implementations, the phase-separable glasses formed from the compositions disclosed herein, as employed as the controlled release agent of the second phase particles 20 of the antimicrobial floor coating 100, can include 10 to 50 mol % cuprite, and all ranges and subranges therebetween, of the phase-separable glass.

In some embodiments, the phase-separable glasses, as employed as the controlled release agent of the second phase particles 20, of the antimicrobial floor coating 100 may include about 70 wt. % Cu¹⁺ or more and about 30 wt. % of Cu¹⁺ or less. The Cu¹⁺ ions may be present in tenorite form and/or even in the glass (i.e., not as a crystalline phase).

In some embodiments, the total amount of Cu by wt. % in the phase-separable glasses, as employed as the controlled release agent of the second phase particles 20, of the antimicrobial floor coating 100 may be in the range from about 10 to about 30, from about 15 to about 25, from about 11 to about 30, from about 12 to about 30, from about 13 to about 30, from about 14 to about 30, from about 15 to about 30, from about 16 to about 30, from about 17 to about 30, from about 18 to about 30, from about 19 to about 30, from about 20 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 16 to about 24, from about 17 to about 23, from about 18 to about 22, from about 19 to about 21, and all ranges and sub-ranges therebetween. In one or more embodiments, the ratio of Cu¹⁺ ions to the total amount Cu in the glass is about 0.5 or greater, 0.55 or greater, 0.6 or greater, 0.65 or greater, 0.7 or greater, 0.75 or greater, 0.8 or greater, 0.85 or greater, 0.9 or greater, or even 1 or greater, and all ranges and sub-ranges therebetween. The amount of Cu and the ratio of Cu¹⁺ ions to total Cu may be determined by inductively coupled plasma (ICP) techniques known in the art.

In some embodiments, the phase-separable glass, as employed as the controlled release agent of the second phase particles 20, of the antimicrobial floor coating 100 may exhibit a greater amount of Cu¹⁺ and/or Cu⁰ than Cu²⁺. For example, based on the total amount of Cu¹⁺, Cu²⁺, and Cu0 in the glasses, the percentage of Cu¹⁺ and Cu⁰, combined, may be in the range from about 50% to about 99.9%, from about 50% to about 99%, from about 50% to about 95%, from about 50% to about 90%, from about 55% to about 99.9%, from about 60% to about 99.9%, from about 65% to about 99.9%, from about 70% to about 99.9%, from about 75% to about 99.9%, from about 80% to about 99.9%, from about 85% to about 99.9%, from about 90% to about 99.9%, from about 95% to about 99.9%, and all ranges and sub-ranges therebetween. The relative amounts of Cu¹⁺, Cu²⁺, and Cu⁰ may be determined using x-ray photoluminescence spectroscopy (XPS) techniques known in the art.

Referring again to FIGS. 1 and 1A, the plurality of second phase particles 20 of the antimicrobial floor coating 100 comprises a controlled release agent, which can employ a phase-separable glass in some embodiments. In particular, the phase-separable glass can comprise at least a first phase and a second phase (distinct from the second phase particles 20). In one or more embodiments, the phase-separable glass may include two or more phases wherein the phases differ based on the ability of the atomic bonds in the given phase to withstand interaction with a leachate. Specifically, the glass of one or more embodiments may include a first phase that may be described as a degradable phase and a second phase that may be described as a durable phase. The phrases “first phase” and “degradable phase” may be used interchangeably. The phrases “second phase” and “durable phase” may be used interchangeably in the context of the phase-separable glass. As used herein, the term “durable” refers to the tendency of the atomic bonds of the durable phase to remain intact during and after interaction with a leachate. As used herein, the term “degradable” refers to the tendency of the atomic bonds of the degradable phase to break during and after interaction with one or more leachates. In one or more embodiments, the durable phase includes SiO₂ and the degradable phase includes at least one of B₂O₃, P₂O₅ and R₂O (where R can include any one or more of K, Na, Li, Rb, and Cs). Without being bound by theory, it is believed that the components of the degradable phase (i.e., B₂O₃, P₂O₅ and/or R₂O) more readily interact with a leachate and the bonds between these components to one another and to other components in the phase-separable glass more readily break during and after the interaction with the leachate. Leachates may include water, acids, or other similar materials. In one or more embodiments, the degradable phase withstands degradation for 1 week or longer, 1 month or longer, 3 months or longer, or even 6 months or longer. In some embodiments, longevity may be characterized as maintaining antimicrobial efficacy over a specific period of time.

In one or more embodiments of the antimicrobial floor coating 100, the durable phase of the phase-separable glass employed in the second phase particles is present in an amount by weight that is greater than the amount of the degradable phase. In some instances, the degradable phase forms islands and the durable phase forms the sea surrounding the islands (i.e., the durable phase). In one or more embodiments, either one or both of the durable phase and the degradable phase may include cuprite. The cuprite in such embodiments may be dispersed in the respective phase or in both phases.

In some embodiments of the phase-separable glass, phase separation occurs without any additional heat treatment of the glass. In some embodiments, phase separation may occur during melting and may be present when the glass composition is melted at temperatures up to and including about 1600° C. or 1650° C. When the glass is cooled, the phase separation is maintained (e.g., in a metastable state).

The phase-separable glass, as described in the foregoing, may be provided in sheet form or may have another shape such as particulate, fibrous, and the like. Referring to FIGS. 1 and 1A, the phase-separable glass is in the form of second phase particles 20, generally bounded by a matrix 10 that comprises a polymeric material. In the second phase particles 20 within the exposed portion of exterior surface 40, the surface portion of the particles 20 may include a plurality of copper ions wherein at least 75% of the plurality of copper ions includes Cu¹⁺-ions. For example, in some instances, at least about 80%, at least about 85%, at least about 90%, at least about 95%, at least about 98%, at least about 99%, or at least about 99.9% of the plurality of copper ions in the surface portion includes Cu¹⁺ ions. In some embodiments, 25% or less (e.g., 20% or less, 15% or less, 12% or less, 10% or less or 8%, or less) of the plurality of copper ions in the surface portion include Cu²⁺ ions. For example, in some instances, 20% or less, 15% or less, 10% or less, 5% or less, 2% or less, 1% or less, 0.5% or less, or 0.01% or less of the plurality of copper ions in the surface portion include Cu²⁺ ions. In some embodiments, the surface concentration of Cu¹⁺ ions in the antimicrobial glass is controlled. In some instances, a Cu¹⁺ ion concentration of about 4 ppm or greater can be provided on the surface of the antimicrobial glass.

The antimicrobial floor coating 100 according to one or more embodiments, and particularly its exterior surfaces 30 and 40 with exposed portions, may exhibit a 2 log reduction or greater (e.g., 2.5, 3, 3.5, 4, 4.5, 5, 5.5, 6, 6.5 log, and all ranges and sub-ranges therebetween) in a concentration of at least one of Staphylococcus aureus, Enterobacter aerogenes, Pseudomonas aeruginosa, methicillin-resistant Staphylococcus aureus (MRSA), and E. coli bacteria under the modified United States Environmental Protection Agency “Test Method for Efficacy of Copper Alloy Surfaces as a Sanitizer” testing conditions, wherein the modified conditions include substitution of the antimicrobial floor coating with the copper-containing surface prescribed in the Method and use of copper metal article as the prescribed control sample in the Method (collectively, the “Modified EPA Copper Test Protocol”). As such, the United States Environmental Protection Agency “Test Method for Efficacy of Copper Alloy Surfaces as a Sanitizer” is hereby incorporated by reference in its entirety within the disclosure. In some instances, the antimicrobial floor coatings exhibit at least a 4 log reduction, a 5 log reduction, or even a 6 log reduction in the concentration of at least one of Staphylococcus aureus, Enterobacter aerogenes, Pseudomonas aeruginosa bacteria, MRSA, and E. coli under the Modified EPA Copper Test Protocol. Further, it should be noted that the degree of antimicrobial efficacy of the antimicrobial floor coating 100 can include the demonstration of a 2 log reduction in a concentration of Staphylococcus aureus (S. aureus), as determined under a test procedure derived from a protocol of the United States Environmental Protection Agency (the “Modified EPA Copper Test Protocol”). As S. aureus is one of the key bacteria against which a kill must be demonstrated by the Modified EPA Copper Test Protocol, a kill of S. aureus may be considered reasonable evidence of efficacy against a broad range of other bacteria (e.g., Eschecheria coli, Pseudomonas aeruginosa, and Enterobacter aerogenes), as understood by those with ordinary skill in the field of this disclosure.

The antimicrobial floor coating 100 according to one or more embodiments may exhibit the log reductions described herein for long periods of time. In other words, the antimicrobial floor coating 100 may exhibit extended or prolonged antimicrobial efficacy. For example, in some embodiments, the antimicrobial floor coating 100 may exhibit the log reductions described herein under the Modified EPA Copper Test Protocol for a week, two weeks, three weeks, up to 1 month, up to 3 months, up to 6 months, or up to 12 months after the antimicrobial floor coating 100 is formed.

According to one or more embodiments, the phase-separable glass, as employed as the controlled release agent of the second phase particle 20, may exhibit a preservative function, when combined with the matrix 10 described herein. In such embodiments, the phase-separable glass may kill or eliminate, or reduce the growth of various foulants in the matrix 10. Foulants include fungi, bacteria, viruses, and combinations thereof.

According to one or more embodiments, the antimicrobial floor coating 100 containing the phase-separable glasses described herein leach copper ions when exposed or in contact with a leachate. In one or more embodiments, the glass leaches only copper ions when exposed to leachates including water.

In one or more embodiments, the antimicrobial floor coating 100 described herein may have a tunable antimicrobial activity release. The antimicrobial activity of the phase-separable glass may be caused by contact between the second phase particles 20 containing the glass and a leachate, such as water, where the leachate causes Cu¹⁺ ions to be released from the glass. This action may be described as water solubility and the water solubility can be tuned to control the release of the Cu⁺¹ ions.

In some embodiments, where the Cu¹⁺ ions are disposed in the glass network and/or form atomic bonds with the atoms in the glass network of the phase-separable glass, water or humidity breaks those bonds and the Cu¹⁺ ions available for release and may be exposed on the second phase particles 20.

In one or more embodiments of the antimicrobial floor coating 100, the phase-separable glass may be formed in low cost melting tanks that are typically used for melting glass compositions such as soda lime silicate. Such phase-separable glass may be formed into a sheet form or directly into a particulate using forming processes known in the art. For instance, example forming methods include float glass processes and down-draw processes such as fusion draw and slot draw. When the phase-separable glass is formed into a sheet, it is subsequently ground or otherwise processed to form the second phase particles 20 employed in the antimicrobial floor coating 100.

As noted earlier, the antimicrobial floor coating 100 (see FIGS. 1 & 1A) includes a matrix 10 that comprises a polymeric material. In embodiments, the polymeric material comprises an epoxy and an acrylic. According to an implementation of the coating 100, the polymeric material is derived from a no-mix, one-part epoxy acrylic floor paint. Various one-part epoxy acrylic floor paints can be employed in the antimicrobial floor coating 100, including but not limited to Behr Premium® 1-Part Epoxy Concrete & Garage Floor Paint (from Behr Process Corporation), Drylock® E1 1-Part Epoxy Floor Paint (from United Gilsonite Laboratories), and Kilz® 1-Part Epoxy Acrylic Concrete & Garage Floor Paint (from Masterchem Industries LLC).

According to some embodiments, the matrix 10 of the antimicrobial floor coating 100 (see FIGS. 1 & 1A) comprises an epoxy that is derived from an epoxy precursor that comprises one or more of dipropylene glycol monomethyl ether, dipropylene glycol butoxy ether, and ethylene glycol. In further embodiments, the matrix 10 of the antimicrobial floor coating 100 comprises an acrylic that comprises a styrene acrylic polymer. In some implementations, the matrix 10 can further comprise nepheline syenite.

In one or more embodiments, the phase-separable glass may be provided in particulate form as second phase particles 20. In this form, the phase-separable glass may have a diameter in the range from about 0.1 micrometers (μm) to about 10 micrometers (μm), from about 0.1 micrometers (μm) to about 9 micrometers (μm), from about 0.1 micrometers (μm) to about 8 micrometers (μm), from about 0.1 micrometers (μm) to about 7 micrometers (μm), from about 0.1 micrometers (μm) to about 6 micrometers (μm), from about 0.5 micrometers (μm) to about 10 micrometers (μm), from about 0.75 micrometers (μm) to about 10 micrometers (μm), from about 1 micrometers (μm) to about 10 micrometers (μm), from about 2 micrometers (μm) to about 10 micrometers (μm), from about 3 micrometers (μm) to about 10 micrometers (μm) from about 3 micrometers (μm) to about 6 micrometers (μm), from about 3.5 micrometers (μm) to about 5.5 micrometers (μm), from about 4 micrometers (μm), to about 5 micrometers (μm), and all ranges and sub-ranges therebetween. The glass may be substantially spherical or may have an irregular shape.

The antimicrobial floor coatings 100 depicted in FIGS. 1 & 1A offer a combination of (a) the plurality of second phase particles 20 comprising a controlled release agent, with the agent comprising a plurality of antimicrobial copper ions, and (b) the matrix 10 of a polymeric material, as comprising an epoxy and an acrylic, that provides substantially greater antimicrobial efficacy as compared to floor coatings comprising epoxy matrix materials and no other polymer, along with antimicrobial copper ions. Without being bound by theory, it is believed that the matrix 10 of the antimicrobial floor coatings 100 have a lower density and/or level of encapsulation of their antimicrobial copper ions as compared to the matrix of floor coatings comprised of two-part epoxy and antimicrobial copper ions.

In some embodiments, the antimicrobial floor coatings 100 described herein may include one or more fillers including pigments, that are typically metal based inorganics can also be added for color and other purposes, e.g., aluminum pigments, copper pigments, cobalt pigments, manganese pigments, iron pigments, titanium pigments, tin pigments, clay earth pigments (naturally formed iron oxides), carbon pigments, antimony pigments, barium pigments, and zinc pigments.

A further aspect of the present disclosure pertains to an antimicrobial floor coating formulation, which when dried and/or cured results in an antimicrobial floor coating 100 (see FIGS. 1 & 1A). Unless otherwise noted, the antimicrobial floor coating 100 formed from these formulations is the same or substantially similar in structure and properties as compared to the antimicrobial floor coatings 100 outlined earlier in the disclosure, with like-numbered elements having the same function and structure. In particular, these antimicrobial floor coating formulations can include an epoxy, an acrylic polymer, an aqueous medium, and a plurality of second phase particles 20 comprising a controlled release agent, the controlled release agent comprising a plurality of antimicrobial copper ions. Further, the plurality of second phase particles 20 is at a concentration that ranges from about 25 g/gal to about 150 g/gal of the formulation, from about 25 g/gal to about 125 g/gal of the formulation, from about 25 g/gal to about 100 g/gal of the formulation, from about 25 g/gal to about 75 g/gal of the formulation, from about 25 g/gal to about 50 g/gal of the formulation, from about 50 g/gal to about 150 g/gal of the formulation, from about 50 g/gal to about 125 g/gal of the formulation, from about 50 g/gal to about 100 g/gal of the formulation, from about 50 g/gal to about 75 g/gal of the formulation, from about 75 g/gal to about 150 g/gal of the formulation, from about 75 g/gal to about 125 g/gal of the formulation, from about 75 g/gal to about 100 g/gal of the formulation, from about 100 g/gal to about 150 g/gal of the formulation, from about 100 g/gal to about 125 g/gal of the formulation, and all concentrations of the second phase particles 20 between these values.

In further implementations of this aspect, an exterior surface of the formulation upon drying of the aqueous medium, e.g., as an antimicrobial floor coating 100, exhibits at least a 2 log reduction in a concentration of Staphylococcus aureus under a Modified EPA Copper Test Protocol. Accordingly, the foregoing formulations can be dried and/or cured to form an antimicrobial floor coating 100, which exhibits the antimicrobial efficacy outlined earlier in the disclosure.

In further implementations of these floor coating formulations, used to form an antimicrobial floor coating 100, the epoxy, the acrylic polymer, and the aqueous medium are derived from a no-mix, one-part epoxy acrylic floor paint. These floor paints can include, according to some embodiments, Behr Premium® 1-Part Epoxy Concrete & Garage Floor Paint (from Behr Process Corporation), Drylock® E1 1-Part Epoxy Floor Paint (from United Gilsonite Laboratories), and Kilz® 1-Part Epoxy Acrylic Concrete & Garage Floor Paint (from Masterchem Industries LLC). Further, the epoxy of the formulation can be derived from an epoxy precursor that comprises one or more of dipropylene glycol monomethyl ether, dipropylene glycol butoxy ether, and ethylene glycol, the acrylic of the formulation can comprise a styrene acrylic polymer, and the matrix 10 of the formulation can further comprise nepheline syenite.

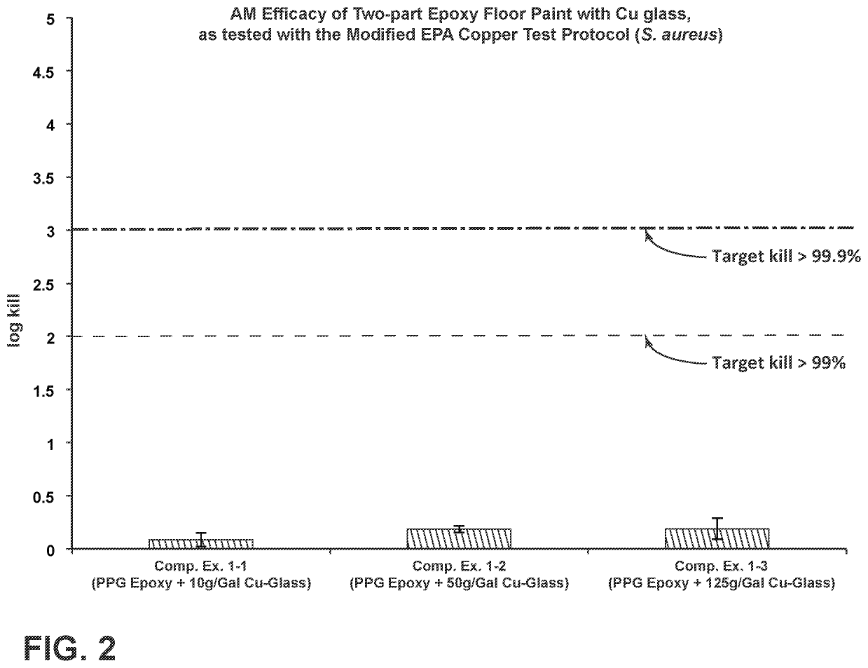

Referring to FIG. 2, a bar chart is provided that depicts the antimicrobial efficacy of comparative two-part epoxy floor paint coatings with phase-separable, copper-containing glass, as tested under the Modified EPA Copper Test Protocol. Each of these samples, denoted by Comp. Ex. 1-1, Comp. Ex. 1-2, and Comp. Ex 1-3, was formulated from a mixture of PPG Industries, Inc. 2-part Epoxy Floor Paint and 10 g/gal, 50 g/gal, and 125 g/gal of antimicrobial copper glass, respectively, having a Cu-Glass composition. Further, each of these samples was painted on a plastic substrate and cured for more than 48 hours. The painted coupons were then tested for antimicrobial efficacy against Staphyloccocus aureus using the Modified EPA Copper Test Protocol. Further, log kill was calculated according to the test method: log kill=log (bacterial number on the control)−log (bacterial number on the sample).

As is evident from the results of FIG. 2, the amount of kill observed was <<90% for all samples. Without being bound by theory, it is believed that the highly cross-linked two-part epoxy of Comp. Exs. 1-1 to 1-3 provided a highly sealed surface that blocked the diffusion of Cu¹⁺ ions to the bacteria on the coated surface of the test coupons. Hence, these paint formulations disadvantageously inhibit contact between the antimicrobial copper ions and the bacteria.

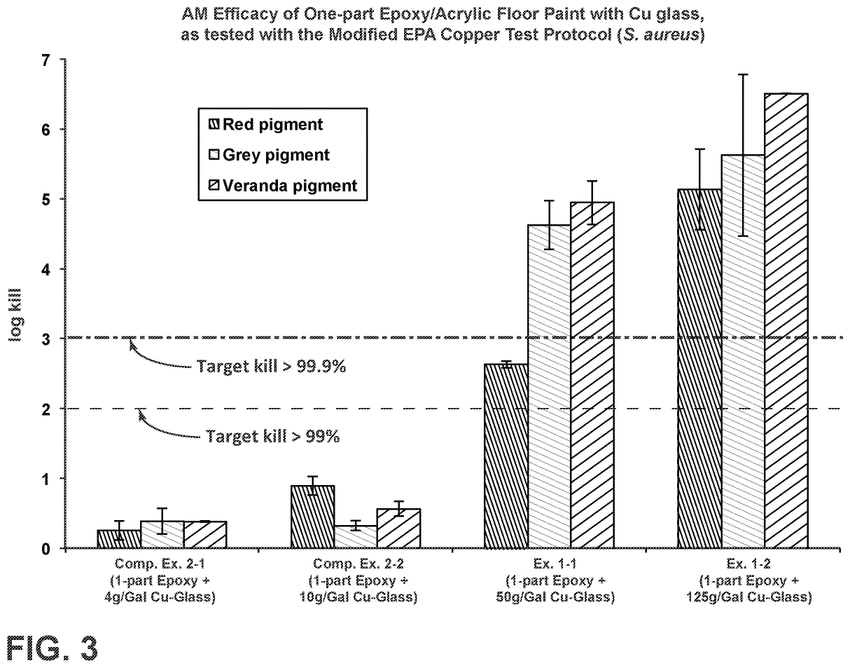

Referring now to FIG. 3, a bar chart is provided that depicts the antimicrobial efficacy of one-part epoxy/acrylic floor paint with phase-separable, copper-containing glass, as tested under the Modified EPA Copper Test Protocol, according to aspects of the disclosure. Each of these samples, denoted by Comp. Ex. 2-1, Comp. Ex. 2-2, Ex. 1-1, and Ex. 1-2, was formulated from a mixture of Behr Premium® 1-Part Epoxy Concrete & Garage Floor Paint (from Behr Process Corporation) and 4 g/gal, 10 g/gal, 50 g/gal, and 125 g/gal of second phase particles of antimicrobial copper glass, respectively, having a Cu-Glass composition. Further, each of these samples was painted on a plastic substrate and cured for more than 48 hours. The painted coupons were then tested for antimicrobial efficacy against Staphyloccocus aureus using the Modified EPA Copper Test Protocol. Further, log kill was calculated according to the test method: log kill=log (bacterial number on the control)−log (bacterial number on the sample).

As is evident from the results of FIG. 3, the amount of kill observed was <99% for those samples formulated with a 4 g/gal and 10 g/gal concentration (Comp. Ex. 2-1 and Comp. Ex. 2-2) and >99% for those samples formulated with a 50 g/gal and 125 g/gal concentration (Ex. 1-1 and Ex. 1-2). These one-part epoxy acrylic-based antimicrobial coatings are derived from no mix formulas, which do not require mixing of different containers of epoxy and hardener. The relative amounts and types of epoxies and acrylics in the resin of these coatings can bury the epoxide moieties from the water dispersed hardener; consequently, upon coating and drying, the epoxy and hardening agents come into contact with one another to provide a durable floor coating. Without being bound by theory, it is believed that the resulting polymer matrix from these one-part epoxy acrylic floor coatings does not overly seal or encapsulate the antimicrobial copper glass particles in the formulation to an extent that inhibits antimicrobial efficacy. Further, results in FIG. 3 demonstrate that the concentration of the antimicrobial copper ions in these floor coatings has a significant effect on the antimicrobial efficacy of the coating.

Aspect (1) of this disclosure pertains to an antimicrobial floor coating, comprising: a matrix comprising a polymeric material; and a plurality of second phase particles comprising a controlled release agent, the controlled release agent comprising a plurality of antimicrobial copper ions, wherein the polymeric material comprises an epoxy and an acrylic, wherein the plurality of particles is distributed within the matrix, and further wherein an exterior surface of the coating exhibits at least a log 2 reduction in a concentration of Staphylococcus aureus under a Modified EPA Copper Test Protocol.

Aspect (2) of this disclosure pertains to the antimicrobial floor coating of Aspect (1), wherein the controlled release agent further comprises a phase-separable glass.

Aspect (3) of this disclosure pertains to the antimicrobial floor coating of Aspect (2), wherein an exterior surface of the coating exhibits at least a log 3 reduction in a concentration of Staphylococcus aureus under a Modified EPA Copper Test Protocol.

Aspect (4) of this disclosure pertains to the antimicrobial floor coating of any one of Aspects (2) or (3), further comprising one or more pigments.

Aspect (5) of this disclosure pertains to the antimicrobial floor coating of any one of Aspects (2) through (4), wherein the plurality of antimicrobial copper ions is at a concentration of about 2 wt. % or less in the coating.

Aspect (6) of this disclosure pertains to the antimicrobial floor coating of any one of Aspects (2) through (5), wherein the phase-separable glass comprises at least one of B₂O₃, P₂O₅ and R₂O, and the plurality of antimicrobial ions is cuprite comprising a plurality of Cu′ ions.

Aspect (7) of this disclosure pertains to the antimicrobial floor coating of any one of Aspects (2) through (6), wherein the phase-separable glass comprises: SiO₂ in the range from about 40 to about 70 mol %, Al₂O₃ in the range from about 0 to about 20 mol %, Cu-containing oxide in the range from about 10 to about 50 mol %, CaO in the range from about 0 to about 15 mol %, MgO in the range from about 0 to about 15 mol %, P₂O₅ in the range from about 0 to about 25 mol %, B₂O₃ in the range from about 0 to about 25 mol %, K₂O in the range from about 0 to about 20 mol %, ZnO in the range from about 0 to about 5 mol %, Na₂O in the range from about 0 to about 20 mol %, Fe₂O₃ in the range from about 0 to about 5 mol %, and an optional nucleating agent comprising either one or both of TiO₂ and ZrO₂, wherein the amount of the Cu-containing oxide is greater than the amount of Al₂O₃.

Aspect (8) of this disclosure pertains to the antimicrobial floor coating of any one of Aspects (2) through (7), wherein the polymeric material is derived from a no-mix, one-part epoxy acrylic floor paint.

Aspect (9) of this disclosure pertains to the antimicrobial floor coating of Aspect (8), wherein the phase-separable glass comprises: about 45 mol % SiO₂, about 35 mol % CuO, about 7.5 mol % K₂O, about 7.5 mol % B₂O₃ and about 5 mol % P₂O₅.

Aspect (10) of this disclosure pertains to the antimicrobial floor coating of Aspect (9), wherein the epoxy is derived from an epoxy precursor that comprises one or more of dipropylene glycol monomethyl ether, dipropylene glycol butoxy ether, and ethylene glycol, wherein the acrylic comprises a styrene acrylic polymer, and further wherein the matrix further comprises nepheline syenite.

Aspect (11) of this disclosure pertains to an antimicrobial floor coating formulation, comprising: an epoxy; an acrylic polymer; an aqueous medium; and a plurality of second phase particles comprising a controlled release agent, the controlled release agent comprising a plurality of antimicrobial copper ions, wherein the plurality of second phase particles is at a concentration that ranges from about 25 g/gallon to about 150 g/gallon of the formulation.

Aspect (12) of this disclosure pertains to the floor coating formulation according to Aspect (11), wherein the controlled release agent further comprises a phase-separable glass.

Aspect (13) of this disclosure pertains to the floor coating formulation according to Aspect (12), further comprising one or more pigments.

Aspect (14) of this disclosure pertains to the floor coating formulation according to Aspect (12) or (13), wherein the phase-separable glass comprises at least one of B₂O₃, P₂O₅ and R₂O, and the plurality of antimicrobial copper ions is cuprite comprising a plurality of Cu⁺ ions.

Aspect (15) of this disclosure pertains to the floor coating formulation according to any one of Aspects (12) through (14), wherein the phase-separable glass comprises: SiO₂ in the range from about 40 to about 70 mol %, Al₂O₃ in the range from about 0 to about 20 mol %, Cu-containing oxide in the range from about 10 to about 50 mol %, CaO in the range from about 0 to about 15 mol %, MgO in the range from about 0 to about 15 mol %, P₂O₅ in the range from about 0 to about 25 mol %, B₂O₃ in the range from about 0 to about 25 mol %, K₂O in the range from about 0 to about 20 mol %, ZnO in the range from about 0 to about 5 mol %, Na₂O in the range from about 0 to about 20 mol %, Fe₂O₃ in the range from about 0 to about 5 mol %, and an optional nucleating agent comprising either one or both of TiO₂ and ZrO₂, wherein the amount of the Cu-containing oxide is greater than the amount of Al₂O₃.

Aspect (16) of this disclosure pertains to the floor coating formulation according to any one of Aspects (12) through (15), wherein the epoxy, the acrylic polymer and the aqueous medium are derived from a no-mix, one-part epoxy acrylic floor paint.

Aspect (17) of this disclosure pertains to the floor coating formulation according to Aspect (16), wherein the phase-separable glass comprises: about 45 mol % SiO₂, about 35 mol % CuO, about 7.5 mol % K₂O, about 7.5 mol % B₂O₃ and about 5 mol % P₂O₅.

Aspect (18) of this disclosure pertains to the floor coating formulation according to Aspect (17), wherein the epoxy is derived from an epoxy precursor that comprises one or more of dipropylene glycol monomethyl ether, dipropylene glycol butoxy ether, and ethylene glycol, wherein the acrylic polymer comprises a styrene acrylic polymer, and further wherein the matrix comprises a nepheline syenite.

Aspect (19) of this disclosure pertains to the floor coating formulation according to any one of Aspects (12) through (18), wherein the plurality of second phase particles is at a concentration that ranges from about 50 g/gallon to about 125 g/gallon of the formulation.

Aspect (20) of this disclosure pertains to the floor coating formulation according to any one of Aspects (12) through (19), wherein an exterior surface of the formulation upon drying of the aqueous medium exhibits at least a log 2 reduction in a concentration of Staphylococcus aureus under a Modified EPA Copper Test Protocol.

It will be apparent to those skilled in the art that various modifications and variations can be made without departing from the spirit or scope of the invention.

1. An antimicrobial floor coating, comprising:
a matrix comprising a polymeric material; and
a plurality of second phase particles comprising a controlled release agent, the controlled release agent comprising a plurality of antimicrobial copper ions,
wherein the polymeric material comprises an epoxy and an acrylic,
wherein the plurality of particles is distributed within the matrix, and
further wherein an exterior surface of the coating exhibits at least a log 2 reduction in a concentration of Staphylococcus aureus under a Modified EPA Copper Test Protocol.

2. The floor coating according to claim 1, wherein the controlled release agent further comprises a phase-separable glass.

3. The floor coating according to claim 2, wherein an exterior surface of the coating exhibits at least a log 3 reduction in a concentration of Staphylococcus aureus under a Modified EPA Copper Test Protocol.

4. The floor coating according to claim 2, further comprising one or more pigments.

5. The floor coating according to claim 2, wherein the plurality of antimicrobial copper ions is at a concentration of about 2 wt. % or less in the coating.

6. The floor coating according to claim 2, wherein the phase-separable glass comprises at least one of B₂O₃, P₂O₅ and R₂O, and the plurality of antimicrobial ions is cuprite comprising a plurality of Cu⁺ ions.

7. The floor coating according to claim 2, wherein the phase-separable glass comprises:
SiO₂ in the range from about 40 to about 70 mol %,
Al₂O₃ in the range from about 0 to about 20 mol %,
Cu-containing oxide in the range from about 10 to about 50 mol %,
CaO in the range from about 0 to about 15 mol %,
MgO in the range from about 0 to about 15 mol %,
P₂O₅ in the range from about 0 to about 25 mol %,
B₂O₃ in the range from about 0 to about 25 mol %,
K₂O in the range from about 0 to about 20 mol %,
ZnO in the range from about 0 to about 5 mol %,
Na₂O in the range from about 0 to about 20 mol %,
Fe₂O₃ in the range from about 0 to about 5 mol %, and
an optional nucleating agent comprising either one or both of TiO₂ and ZrO₂, wherein the amount of the Cu-containing oxide is greater than the amount of Al₂O₃.

8. The floor coating according to claim 2, wherein the polymeric material is derived from a no-mix, one-part epoxy acrylic floor paint.

9. The floor coating according to claim 8, wherein the phase-separable glass comprises: about 45 mol % SiO₂, about 35 mol % CuO, about 7.5 mol % K₂O, about 7.5 mol % B₂O₃ and about 5 mol % P₂O₅.

10. The floor coating according to claim 9, wherein the epoxy is derived from an epoxy precursor that comprises one or more of dipropylene glycol monomethyl ether, dipropylene glycol butoxy ether, and ethylene glycol, wherein the acrylic comprises a styrene acrylic polymer, and further wherein the matrix further comprises nepheline syenite.

11. An antimicrobial floor coating formulation, comprising:
an epoxy;
an acrylic polymer;
an aqueous medium; and
a plurality of second phase particles comprising a controlled release agent, the controlled release agent comprising a plurality of antimicrobial copper ions,
wherein the plurality of second phase particles is at a concentration that ranges from about 25 g/gallon to about 150 g/gallon of the formulation.

12. The floor coating formulation according to claim 11, wherein the controlled release agent further comprises a phase-separable glass.

13. The floor coating formulation according to claim 12, further comprising one or more pigments.

14. The floor coating formulation according to claim 12, wherein the phase-separable glass comprises at least one of B₂O₃, P₂O₅ and R₂O, and the plurality of antimicrobial copper ions is cuprite comprising a plurality of Cu⁺ ions.

15. The floor coating formulation according to claim 12, wherein the phase-separable glass comprises:
SiO₂ in the range from about 40 to about 70 mol %,
Al₂O₃ in the range from about 0 to about 20 mol %,
Cu-containing oxide in the range from about 10 to about 50 mol %,
CaO in the range from about 0 to about 15 mol %,
MgO in the range from about 0 to about 15 mol %,
P₂O₅ in the range from about 0 to about 25 mol %,
B₂O₃ in the range from about 0 to about 25 mol %,
K₂O in the range from about 0 to about 20 mol %,
ZnO in the range from about 0 to about 5 mol %,
Na₂O in the range from about 0 to about 20 mol %,
Fe₂O₃ in the range from about 0 to about 5 mol %, and
an optional nucleating agent comprising either one or both of TiO₂ and ZrO₂, wherein the amount of the Cu-containing oxide is greater than the amount of Al₂O₃.

16. The floor coating formulation according to claim 12, wherein the epoxy, the acrylic polymer and the aqueous medium are derived from a no-mix, one-part epoxy acrylic floor paint.

17. The floor coating formulation according to claim 16, wherein the phase-separable glass comprises: about 45 mol % SiO₂, about 35 mol % CuO, about 7.5 mol % K₂O, about 7.5 mol % B₂O₃ and about 5 mol % P₂O₅.

18. The floor coating formulation according to claim 17, wherein the epoxy is derived from an epoxy precursor that comprises one or more of dipropylene glycol monomethyl ether, dipropylene glycol butoxy ether, and ethylene glycol, wherein the acrylic polymer comprises a styrene acrylic polymer, and further wherein the matrix comprises a nepheline syenite.

19. The floor coating formulation according to claim 12, wherein the plurality of second phase particles is at a concentration that ranges from about 50 g/gallon to about 125 g/gallon of the formulation.

20. The floor coating formulation according to claim 12, wherein an exterior surface of the formulation upon drying of the aqueous medium exhibits at least a log 2 reduction in a concentration of Staphylococcus aureus under a Modified EPA Copper Test Protocol.
